(19) United States
(12) Patent Application Publication
(10) Pub. No.: US 2021/0153419 A1
(43) Pub. Date: May 27, 2021

(54) Agricultural Vehicle Having On-Board Speed Control For Sections Of An Application Boom

(71) Applicant: CNH Industrial America LLC, New Holland, PA (US)

(72) Inventors: Steven Winkel, Kiel, WI (US); Nathan Brooks, Manitowoc, WI (US)

(21) Appl. No.: 16/691,000

(22) Filed: Nov. 21, 2019

(51) Int. Cl. A01B 73/06; A01C 23/00

(52) U.S. Cl. CPC A01B 73/067; A01C 23/00

(57) ABSTRACT

According to an aspect of the invention, boom control of an agricultural vehicle can be integrated with an on-board machine controller of the vehicle so that an operator can provide input through a user interface of the machine controller without requiring an ISOBUS interface or VT. In one aspect, an electronic system can integrate ISO controls with an on-board display connected to the machine controller by an integral CAN bus to give an operator the ability to control boom speeds, auto fold the boom and make standard adjustments, without an ISOBUS or VT. In one aspect, using CAN communication on an additional CAN bus, the on-board controller can execute to ensure a Graphical User Interface (GUI) of the on-board display communicates operator intentions to an ISO boom control module associated with the boom. This can allow avoiding the requirement of a VT while still providing VT functionality.

### FIELD OF THE INVENTION

The invention relates generally to agricultural machines having application booms mounted thereon and, in particular, to a system for receiving user selectable input through a control interface of the agricultural vehicle, the user selectable input indicating a speed for folding or unfolding sections of an application boom.

### BACKGROUND

Various types of agricultural vehicles (e.g., sprayers, floaters, applicators, collectively referred to herein as applicators) are employed to deliver fertilizer, pesticides, herbicides, or other products to the surface of a field. Such agricultural vehicles typically include an application boom configured to facilitate product delivery over wide swaths of soil. The application boom typically can be folded inward, toward the vehicle when the boom is not in use, so as to maximize space savings, and unfolded outward, away from the vehicle, when desirable to use the boom for field operations such as spraying.

Modern agricultural vehicles can include an integrated primary system/machine controller for controlling electronic functions of the vehicle, such as steering, hydraulic, electrical, cooling, suspension and driveline control, flow from product/rinse tanks, system calibrations and the like. The system can also provide an ISOBUS for adding electronic equipment, such as a virtual terminal (VT), to communicate with the system/machine controller as desired. ISOBUS is an international standard that ensures compatibility and connectivity between displays, tractors, and implements, regardless of manufacturer. ISOBUS can be implemented, for example, according to ISO 11783, known as tractors and machinery for agriculture and forestry, serial control and communications data network, a communication protocol based on the SAE J1939 protocol. One example of electronic equipment connected to an ISOBUS of an agricultural vehicle is a VT which may provide boom control through an ISO boom control module associated with the boom.

However, sometimes a VT is not active in the system, whether due to availability, cost, failure of the VT or otherwise. It is nevertheless desirable to control aspects of the agricultural vehicle, particularly with respect to the boom, without requiring a VT. A need therefore exists to provide a system for controlling a boom which eliminates one or more of the foregoing disadvantages.

### SUMMARY OF THE INVENTION

According to an aspect of the invention, boom control of an agricultural vehicle can be integrated with an on-board machine controller of the vehicle so that an operator can provide input through a user interface of the machine controller without requiring an ISOBUS interface or VT. In one aspect, an electronic system can integrate ISO controls with an on-board display connected to the machine controller by an integral CAN bus to give an operator the ability to control boom speeds, auto fold the boom and make standard adjustments, without an ISOBUS or VT. In one aspect, using CAN communication on an additional CAN bus, the on-board controller can execute to ensure a Graphical User Interface (GUI) of the on-board display communicates operator intentions to an ISO boom control module associated with the boom. This can allow avoiding the requirement of a VT while still providing VT functionality.

Specifically, then, one aspect of the invention can provide a system for controlling an application boom mounted to an agricultural vehicle. The system can include: an application boom configured to deliver agricultural product to a field, the application boom having multiple actuators configured to fold and unfold the boom relative to the agricultural vehicle; a machine controller of the agricultural vehicle, the machine controller having a control interface configured to receive user selectable input, the machine controller being in communication with the actuators, the machine controller having a processor executing a program stored in a non-transient medium operable to: receive, through the control interface, user selectable input indicating a speed for folding or unfolding the boom relative to the agricultural vehicle; and control the actuators to fold or unfold the boom at the speed indicated by the user selectable input.

Other aspects, objects, features, and advantages of the invention will become apparent to those skilled in the art from the following detailed description and accompanying drawings. It should be understood, however, that the detailed description and specific examples, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Preferred exemplary embodiments of the invention are illustrated in the accompanying drawings in which like reference numerals represent like parts throughout.

FIG. 1 is an isometric view of a front-boom sprayer from a first perspective, where the boom is folded, in a raised and retracted position;

FIG. 2 is an isometric view from a second perspective of the front-boom sprayer of FIG. 1, where the boom is in a raised position, the right boom arm is removed, a first boom arm segment of the left boom arm is in an extended positioned, and second and third boom arm segments of the left boom arm are in the retracted position;

FIG. 3 is an isometric view from the second perspective of the front-boom sprayer of FIG. 1, where the boom is in a lowered position, the right boom arm is removed, the first boom arm segment of the left boom arm is in the extended positioned, and the second and third boom arm segments of the left boom arm are in the retracted position;

FIG. 4 is an isometric view from the second perspective of the front-boom sprayer of FIG. 1, where the boom is unfolded, in a lowered and fully extended position;

FIG. 5 is a diagram of a system for controlling the boom through a machine controller and user interface; and

FIG. 6 is an exemplar screen of the user interface of FIG. 5 for controlling speed of the boom.

### DETAILED DESCRIPTION OF THE DRAWINGS

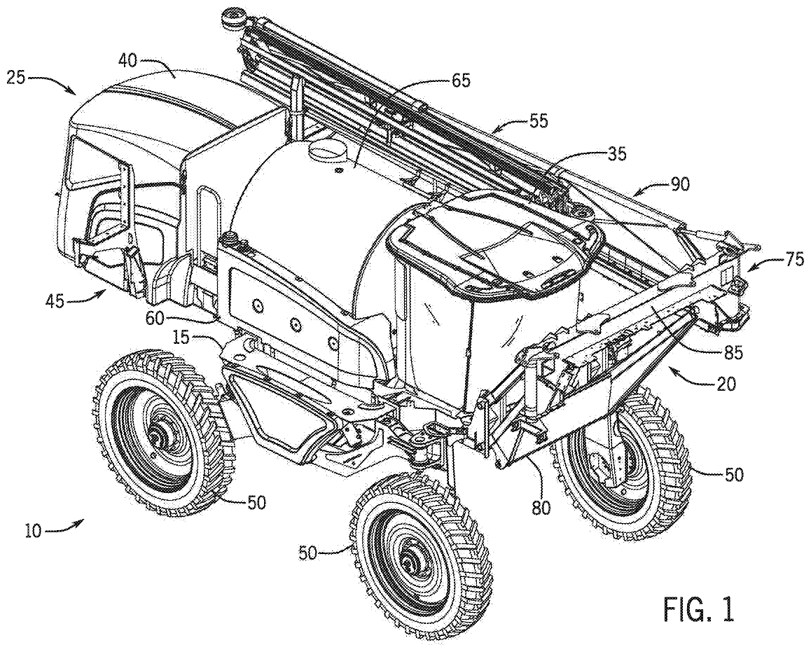

Referring now to the drawings and specifically to FIGS. 1-4, aspects of the invention are shown for use with an agricultural vehicle, which is shown in the figures to be an agricultural sprayer vehicle (referred to herein as simply a “sprayer”) 10. The sprayer 10 is shown as a front-boom sprayer, such as those available from CNH Industrial, including the Miller Nitro sprayers and New Holland Guardian Series sprayers. Other arrangements for the sprayer 10 are contemplated, including a rear-mounted configuration boom sprayer, such as those available from CNH Industrial, including the Miller Condor Series sprayers and New Holland Guardian Series rear-boom sprayers. Moreover, other agriculture machines and vehicles incorporating aspects of the invention are contemplated, including agriculture vehicles having a boom.

The sprayer 10 includes a frame or chassis 15 having front and back ends 20 and 25, respectively. The chassis 15 provides structural support for various assemblies, systems, and components of the sprayer 10. These various assemblies, systems, and components can include an operator cab 35 in a forward position toward the front end 20 of the chassis 15. An engine 40 and a hydraulic system 45 are shown in a rearward position toward the back end 25 of the chassis 15, The hydraulic system 45 receives power from the engine 40 and includes at least one hydraulic pump which can be in a hydrostat arrangement. The hydraulic pump(s) provide hydraulic pressure for operating hydraulic components within the hydraulic system 45. For sprayers with hydrostatic drives, hydraulic motors are operably connected to the hydraulic pump(s) for rotating wheels 50 of the sprayer 10. In mechanical drive applications, a mechanical transmission receives power from the engine 40 and delivers power for rotating the wheels 50 by way of power-transmitting driveline components. Example power-transmitting driveline components include drive shafts, differentials, and other gear sets in portal, drop boxes, or other housings.

A spray-application system 55 is supported by the chassis 15. The spray-application system 55 includes storage containers, such as a rinse tank 60 for storing water or a rinsing solution and a product tank 65 for storing a volume of product for delivery onto an agricultural field with the sprayer 10. The product includes any of a variety of agricultural liquid products, such as various pesticides, herbicides, fungicides, liquid fertilizers, and other liquids including liquid suspensions beneficial for application onto agricultural fields. A product delivery pump can convey product from the product tank 65 through plumbing components to nozzle bodies on an application boom 75. The plumbing components includes a piping system for transport of the product from the tank to the nozzle bodies. The nozzle bodies are spaced from each other along the width of boom 75 for spraying operations of the sprayer 10. Groups or banks of multiple adjacent nozzle bodies define multiple spray sections or segments of the spray system. Spray segments are defined along the boom 75 and selectively deliver product for release onto an agricultural field at locations corresponding to positions of activated spray segments.

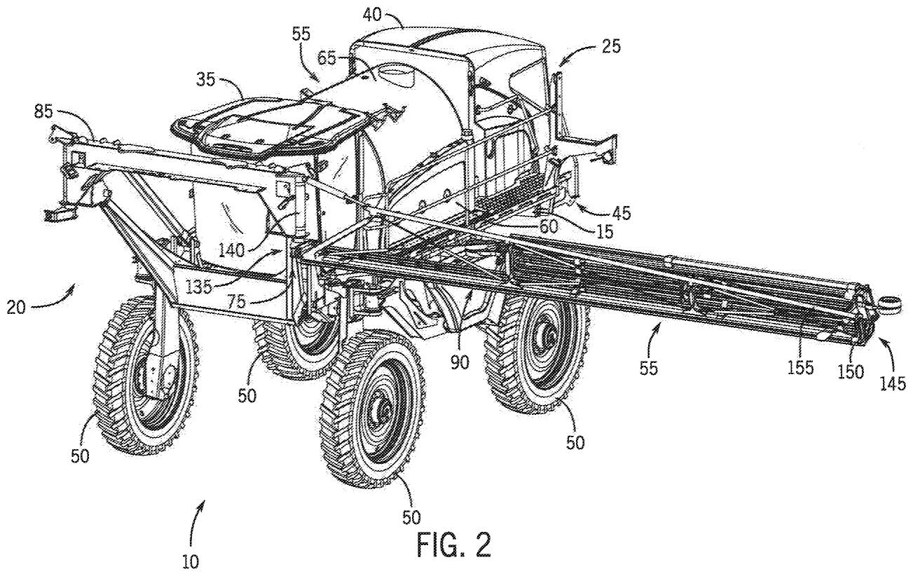

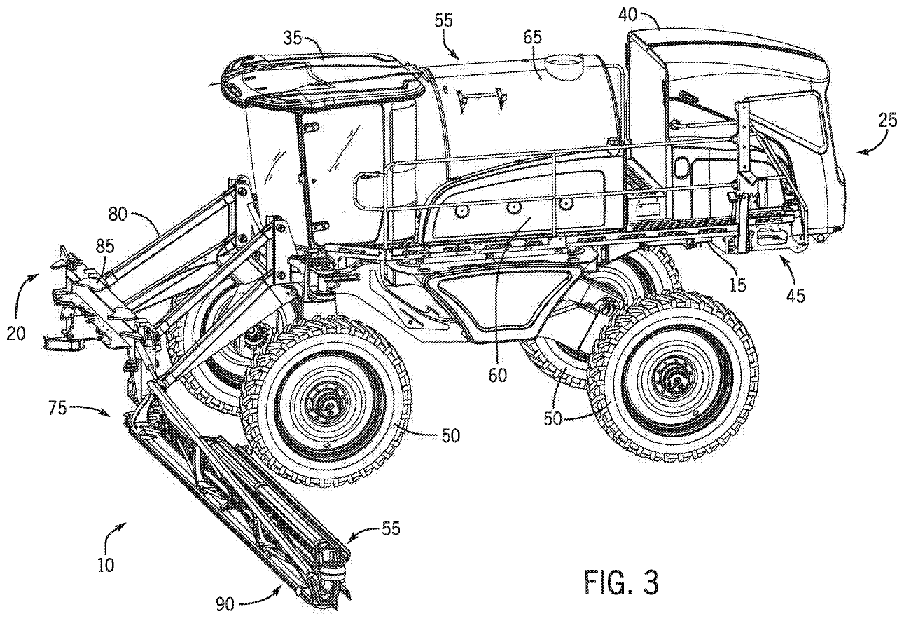

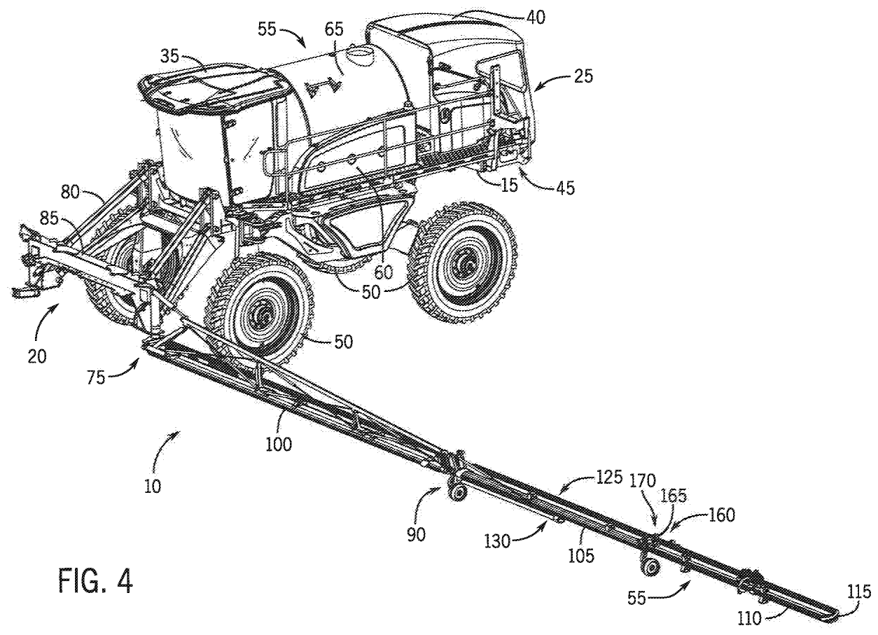

The boom 75 is connected to the chassis 15 with a lift arm arrangement or assembly 80. The lift arm assembly 80 is attached to a boom center section 85. The lift arm assembly 80 is configured to move the boom 75 up and down for adjusting the height of application of the product and/or to raise the boom 75 above objects (e.g., agricultural product). FIGS. 1 and 2 show the boom in a raised position, and FIGS. 3 and 4 show the boom in a lowered position.

Coupled to the boom center section 85, the boom 75 has multiple interconnected sections or segments that collectively define each of a left and right boom arm, respectively. Left and right for the boom 75 are defined with respect to an operator's view of the boom 75 from the operator cab 35. Left and right boom arms extend in opposite directions from the boom center section 85. The left and right boom arms are mirror identical about a longitudinal axis of the sprayer 10, and thus, only left boom arm 90 is shown and described in further detail. For simplicity, FIGS. 1-4 show the right boom arm removed. FIG. 1 shows the left boom arm 90 in a retracted, or transport, position. FIGS. 2-4 show the left boom arm 90 in an extended position.

The left boom arm 90 has multiple segments, including first, second, and third boom arm segments 100, 105, and 110 (FIG. 4), respectively. The number of boom arm segments can vary among sprayer designs. Collectively, the boom center section 85, the left boom aril 90, and the right boom arm define the boom 75, which has left and right ends, respectively. The boom 75 has an inner facing or inward side 125 that faces toward the operator cab 35 and provides a vehicle mounting surface(s) with mounting structures configured for mounting the boom 75 to the lift arm assembly 80. Opposite the inner facing side 125 is an outer facing or outward side 130 of the boom 75 that faces away from the operator cab 35.

FIGS. 2 and 3 show the left boom arm 90 in a first extended, spray position, where only the first segment 100 of the left boom arm 90 is extended. Moreover, FIG. 2 shows the left boom arm 90 at a first spray height and FIG. 3 shows the left boom arm at a second spray height. FIG. 4 shows the left boom arm in a second extended, spray position, where all of the first, second, and third segments 100-110 are extended. The boom center segment and/or the first, second, and third boom arm segments 100-110 are configured with actuators to allow the left boom arm 90 to fold and extend as necessary for operation.

With reference to FIG. 2, the first boom arm segment 100 has an inner end 135 that is connected with hinge 140 to the boom center section 85. The hinge 140 is configured to allow for generally forward/rearward horizontal pivoting of the first boom arm segment 100, and consequently second and third boom arm segments 105 and 110, away/toward the chassis 15 when pivoting the first boom arm segment 100. Each boom arm can be further controlled to tilt when deployed, such as near the hinge 140.

The second boom arm segment 105 has an inner end 145 that is connected with hinge 150 to the outer end 155 of the first boom arm segment 100. The hinge 150 is configured to allow for generally rotating the second boom arm segment 105, and consequently third boom arm segment 110, away/toward the first boom arm segment 100 when pivoting the second boom arm segment 105.

With reference to FIG. 4, the third boom arm segment 110 has an inner end 160 that is connected with hinge 165 to the outer end 170 of the second boom arm segment 100. The hinge 165 is configured to allow for generally rotating the third boom arm segment 110 away/toward the second boom arm segment 105 when pivoting the third boom arm segment 110.

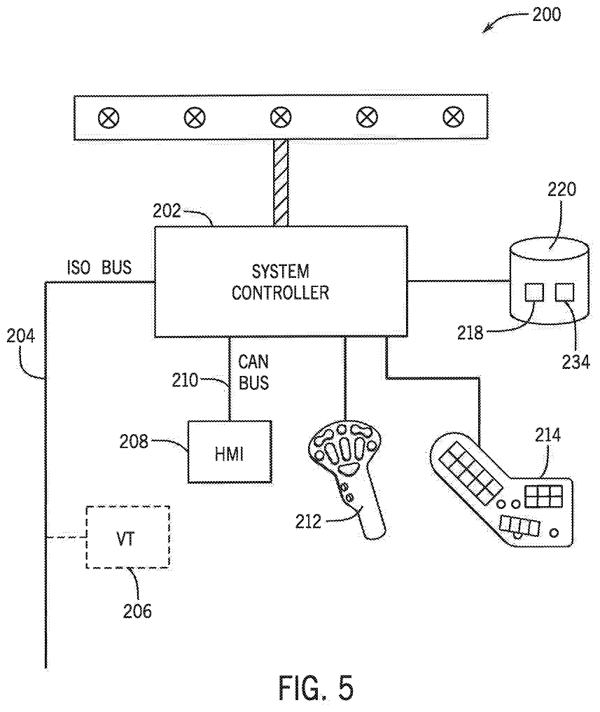

With reference to FIG. 5, according to an aspect of the invention, in an electronic control system 200 for controlling the boom 75, an on-board primary system/machine controller 202 of the sprayer 10 can be arranged for controlling electronic functions of the sprayer, such as steering, hydraulic, electrical, cooling, suspension and driveline control, flow from product/rinse tanks, system calibrations and the like. The machine controller 202 can optionally provide an ISOBUS 204 for adding electronic equipment, such as a virtual terminal (VT) 206, as desired. One example of optional electronic equipment which could connect to the ISOBUS 204 is a VT which may provide boom control through an ISO boom control module associated with the boom 75.

In accordance with the invention, the machine controller 202 can provide a control interface 208 configured to receive user selectable input from a user in the operator cab 35. The control interface 208 can comprise Graphical User Interface (GUI) accessible to the user. The GUI can be part of a Human Machine Interface (HMI) connected to the machine controller 202 through a Controller Area Network (CAN) bus 210. Accordingly, the control interface 208 can be permanently fixed to and integral with the sprayer 10 at the tune of manufacture. This can advantageously allow a more economic and efficient implementation of the control interface 208 in the operator cab 35.

The machine controller 202 can also be in communication a joystick 212 and an armrest 214, each having multiple buttons for supporting the aforementioned various functions of the sprayer 10, among other things. The joystick 212 and/or the armrest 214 can also be connected to the machine controller 202 by separate CAN buses as shown, or by a single, combined CAN bus. The machine controller 202 can also be in communication with a set of actuators 216, including the aforementioned actuators of FIGS. 1-4, to fold or unfold the boom 75 as commanded. The set of actuators 216 can also be controlled by the machine controller 202 by a separate CAN bus as shown, or by a single, combined CAN bus. Each actuator could comprise, for example, a hydraulic cylinder having a solenoid controlled by the machine controller 202 for controlling hydraulic fluid flow to the cylinder for achieving various extensions and retractions thereof.

In one aspect, the machine controller 202 can include a processor executing a program 218 stored in a non-transient medium 220 operable to: receive, through the control interface 208, user selectable input indicating a speed for folding or unfolding the boom 75 relative to the sprayer 10; and control the set of actuators 216 to fold or unfold the boom at the speed indicated by the user selectable input. As a result, the boom 75 can be controlled by the integrated on-board machine controller 202, via input from the operator through the control interface 208, without requiring the ISOBUS 204 or the VT 206. In other words, the system 200 can integrate such ISO controls via the control interface 208 connected to the machine controller 202 by an integral CAN bus 210 to give the user the ability to control boom speeds, auto fold the boom and make standard adjustments, without the ISOBUS 204 or the VT 206. This can allow avoiding the requirement of a VT while still providing VT functionality.

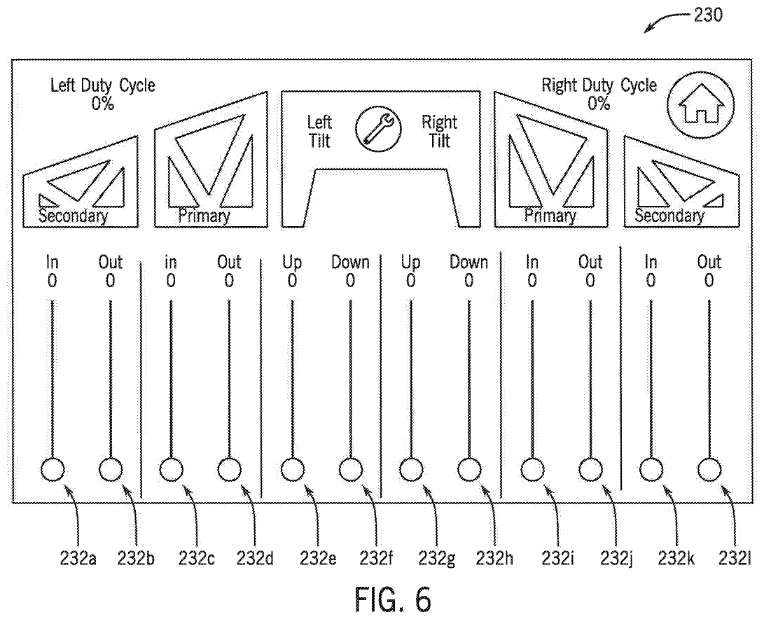

With additional reference to FIG. 6, in one aspect, an exemplar screen 230 of the control interface 208 is provided for controlling speed of the boom 75. The screen 230 illustrates, by way of example, multiple graphical sliders 232a-I, which can be touched and dragged on the screen for adjustment by the user. The sliders 232a-I can be arranged in pairs for controlling folding and unfolding speeds with respect to each segment of the boom 75 by corresponding actuators of the set of actuators 216 controlling the segments. For example, the slider 232a could control a speed for folding (“In”) the second boom arm segment 105 via an actuator at the hinge 150, whereas the slider 232b could control a speed for unfolding (“Out”) the second boom arm segment 105 via the actuator at the hinge 150. In other words, the speed of each hydraulic cylinder can be proportionally controlled, within upper and lower limits, according to its corresponding slider 232 adjusted by the user. Similarly, the slider 232c could control a speed for folding (“In”) the first boom arm segment 100 via an actuator at the hinge 140, whereas the slider 232d could control a speed for unfolding (“Out”) the first boom arm segment 100 via the actuator at the hinge 140, and so forth. Also, some of the sliders 232a-I can be arranged in pairs for controlling tilting speeds with respect to each boom arm relative to the sprayer 10 by corresponding actuators of the set of actuators 216 controlling the boom arm. For example, the slider 232e could control a speed for tilting upward (“Up”) the left boom arm 90 via an actuator at the hinge 140, whereas the slider 232f could control a speed for tilting downward (“Down”) the left boom arm 90 via the actuator at the hinge 140, and so forth.

Each slider could be configured to be adjusted by the user between minimum and maximum values. A minimum value can correspond to a predetermined minimum speed for folding or unfolding the boom, whereas a maximum value can correspond a maximum predetermined speed for folding or unfolding the boom. As illustrated in FIG. 6, each of the sliders 232a-I are set to minimum values (“0”).

In one aspect, upon command from the user, the machine controller 202 can store the user selectable input as default settings 234 in the non-transient medium 220 (see FIG. 5). This can correspond, for example, to various positions of the sliders 232a-1 on the screen 230. Accordingly, the machine controller 202 can initially select a default from the default settings 234, such as upon power up or reset of the system 200.

Although the best mode contemplated by the inventors of carrying out the present invention is disclosed above, practice of the above invention is not limited thereto. It will be manifest that various additions, modifications, and rearrangements of the features of the present invention may be made without deviating from the spirit and the scope of the underlying inventive concept.

What is claimed is:

1. A system for controlling an application boom mounted to an agricultural vehicle, comprising:
an application boom configured to deliver agricultural product to a field, the application boom having a plurality of actuators configured to fold and unfold the boom relative to the agricultural vehicle;
a machine controller of the agricultural vehicle, the machine controller having a control interface configured to receive user selectable input, the machine controller being in communication with the plurality of actuators, the machine controller having a processor executing a program stored in a non-transient medium operable to:
receive, through the control interface, user selectable input indicating a speed for folding or unfolding the boom relative to the agricultural vehicle; and
control the plurality of actuators to fold or unfold the boom at the speed indicated by the user selectable input.

2. The system of claim 1, wherein the control interface comprises Graphical User Interface (GUI) accessible to a user in an operator cab of the agricultural vehicle.

3. The system of claim 2, wherein the GUI is part of a Human Machine Interface (HMI) connected to the machine controller through a Controller Area Network (CAN) bus.

4. The system of claim 2, wherein the GUI comprises a slider configured to be adjusted by the user between minimum and maximum values in which the minimum value corresponds to a minimum speed for folding or unfolding the boom and the maximum value corresponds a maximum speed for folding or unfolding the boom.

5. The system of claim 4, wherein the slider is a first slider among a plurality of sliders, wherein each slider of the plurality of sliders corresponds to an actuator of the plurality of actuators.

6. The system of claim 4, wherein the slider is a first slider, and further comprising a second slider, wherein the first slider indicates a speed for folding the boom and the second slider indicates a speed for unfolding the boom.

7. The system of claim 1, further comprising the machine controller being operable to store the user selectable input as a default in the non-transient medium, wherein the default is initially selected by the machine controller.

8. The system of claim 1, wherein the boom comprises a plurality of segments with an actuator of the plurality of actuators being configured to move each segment.

9. The system of claim 8, wherein the user selectable input comprises a plurality of selections, wherein each selection of the plurality of selections corresponds to an actuator of the plurality of actuators.

10. The system of claim 9, wherein the boom comprises left and right boom arms coupled to a center section in which the left boom arm folds or unfolds relative to a left side of the agricultural vehicle and the right boom arm folds or unfolds relative to a right side of the agricultural vehicle.

11. The system of claim 1, wherein the user selectable input comprises a plurality of selections, wherein at least one selection of the plurality of selections corresponds to a speed for tilting the boom relative to the agricultural vehicle.

12. A method for controlling an application boom mounted to an agricultural vehicle, comprising:
providing an application boom for delivering agricultural product to a field, the application boom having a plurality of actuators for folding and unfolding the boom relative to the agricultural vehicle;
providing a machine controller of the agricultural vehicle, the machine controller having a control interface for receiving user selectable input;
receiving, through the control interface, user selectable input indicating a speed for folding or unfolding the boom relative to the agricultural vehicle; and
controlling the plurality of actuators to fold or unfold the boom at the speed indicated by the user selectable input.

13. The method of claim 12, further comprising providing the control interface with a GUI accessible to a user in an operator cab of the agricultural vehicle.

14. An agricultural vehicle comprising:
a chassis;
wheels supporting the chassis for moving the vehicle;
an application boom supported by the chassis, the application boom configured to deliver agricultural product to a field, the application boom having a plurality of actuators configured to fold and unfold the boom relative to the agricultural vehicle;
an operator cab supported by the chassis;
a machine controller of the agricultural vehicle, the machine controller having a control interface in the operator cab, the control interface being configured to receive user selectable input, the machine controller being in communication with the plurality of actuators, the machine controller having a processor executing a program stored in a non-transient medium operable to:
receive, through the control interface, user selectable input indicating a speed for folding or unfolding the boom relative to the agricultural vehicle; and
control the plurality of actuators to fold or unfold the boom at the speed indicated by the user selectable input.

15. The agricultural vehicle of claim 14, wherein the control interface comprises GUI accessible to a user in the operator cab.

16. The agricultural vehicle of claim 15, wherein the GUI is part of an HMI connected to the machine controller through a CAN bus.

17. The agricultural vehicle of claim 15, wherein the GUI comprises a slider configured to be adjusted by the user between minimum and maximum values in which the minimum value corresponds to a minimum speed for folding or unfolding the boom and the maximum value corresponds a maximum speed for folding or unfolding the boom.

18. The agricultural vehicle of claim 17, wherein the slider is a first slider among a plurality of sliders, wherein each slider of the plurality of sliders corresponds to an actuator of the plurality of actuators.

19. The agricultural vehicle of claim 17, wherein the slider is a first slider, and further comprising a second slider, wherein the first slider indicates a speed for folding the boom and the second slider indicates a speed for unfolding the boom.

20. The agricultural vehicle of claim 14, further comprising the machine controller being operable to store the user selectable input as a default in the non-transient medium, wherein the default is initially selected by the machine controller.
